(19) United States
(12) Patent Application Publication
(10) Pub. No.: US 2001/0026803 A1
(43) Pub. Date: Oct. 4, 2001

(54) Biocide batches based on cross-linked native oils, process for the production thereof and use thereof in thermoplastic molding compositions

(76) Inventors: Heiko Tebbe, Ketsch (DE); Helmut Muller, Kitzingen (DE); Volker Muller, Philippsburg (DE)

Correspondence Address: BAYER CORPORATION, PATENT DEPARTMENT, 100 BAYER ROAD, PITTSBURGH, PA, 15205, US

(21) Appl. No.: 09/791,345

(22) Filed: Feb. 22, 2001

(30) Foreign Application Priority Data
Mar. 2, 2000 (DE) 10010072.4

(51) Int. Cl. A01N 25/34; A01N 25/08

(52) U.S. Cl. 424/416; 424/409; 424/405

(57) ABSTRACT

The present invention relates to biocide batches based on cross-linked native oils, which are used to provide thermoplastic molding compositions with protection against insects and bacterial and fungal attack.

The biocide batches according to the present invention may be incorporated into the thermoplastic molding compositions without releasing during processing dusts or gases hazardous to health and are particularly compatible with the thermoplastic molding compositions to be provided therewith.

### FIELD OF THE INVENTION

The invention relates to biocide batches based on cross-linked native oils, process for the production thereof and the use thereof in thermoplastic molding compositions.

### BACKGROUND OF THE INVENTION

The incorporation of biocides into thermoplastic molding compositions to provide protection from insects and bacterial and fungal attack is generally known, as described for example in “Taschenbuch der Kunststoff-Additive”, Eds. R. Gachter and H. Muller, Carl Hanser Verlag, Munich, 2nd edition (1979), pages 453-469. By incorporating biocides into thermoplastic molding compositions, the moldings produced therefrom are protected from attack by insects, fungi, bacteria and other microorganisms and thus the moldings are prevented from failing prematurely in use. The biocides act by interfering with the metabolism of microorganisms by blocking one or more enzyme systems. In order to be able to achieve effective biocidal action in the thermoplastic molding compositions, the biocides have to be compatible with the thermoplastic molding composition and uniformly dispersed therein. To allow the biological activity thereof to develop fully, the biocide has to come into contact with the microorganisms. To this end, it must migrate to the surfaces, including the inner pore surface, of the thermoplastic molding composition. In some cases, this migration proceeds slowly through the amorphous regions of the thermoplastic molding compositions and in other cases, the biocide migrates to the surface together with plasticizers, which are added to the thermoplastic molding composition. At the surface, the biocides exert their action without danger to humans and animals, since, despite their high toxicity, they are present in the end product only in small concentrations.

Biocides are available in the most varied forms: pulverulent, crystalline, liquid or highly viscous. However, the only forms which may be used in thermoplastic molding compositions are those which may be dispersed rapidly and uniformly in the thermoplastic molding composition.

Although grounded biocide powders or finely crystalline biocides may be readily dispersed in thermoplastic molding compositions, the handling of the generally toxic substances presents a risk to the processor and the environment. Moreover, handling fine powders always entails the risk of dust explosion.

U.S. Pat. No. RE29,409 (reissue) describes a process for reducing handling risk, by dissolving the biocides in liquid solvents. In this case, although handling of the powders is avoided, it is necessary at the same time to handle highly inflammable or poisonous solvents. Moreover, solutions containing active agents are extremely complex to process in thermoplastic molding compositions due to the high temperatures involved in processing.

U.S. Pat. No. 4,086,297 describes the incorporation of biocides into solid supports to yield biocide master batches. Various thermoplastic molding compositions may serve as solid supports. This method avoids handling of fine powders and the risks associated therewith. The biocide master batches are principally supplied as small pellets, which are free- flowing and in which the biocide is immobilized, such that the pellets do not represent any risk to the environment, even when in contact with skin. Despite immobilization of the biocides in the master batch, the biocides still exert their anti-microbial action after incorporation into the thermoplastic molding compositions.

For the biocide master batches to be put to practical use, the biocides have to be present therein in an amount 20 to 200 times higher than in the polymer material subsequently provided therewith. For practical reasons, the concentration of biocides must not be too small, since otherwise, too much pre-processed support material would be present on subsequent use. However, the biocide concentration must not be too high either, since it is otherwise difficult to apportion and distribute upon subsequent final use. Thus, there is a concentration window for the biocide master batches of 20 to 200 times the concentration required for final use. This concentration range may be adhered to only to a limited degree in the case of the incorporation of biocides into thermoplastic support materials as per the above-mentioned U.S. patent, such that the resultant disadvantages have to be tolerated on final use.

Furthermore, the biocides have to be incorporated into the thermoplastic support materials at relatively high temperatures. This exposure to elevated temperatures has to occur twice: once in the production of the master batch and the second time in the incorporation of the biocide master batch into the polymer to be provided therewith. This production and processing process required by the high melting range of the thermoplastics may result in thermal decomposition of the biocides, which may lead to an uncontrollable reduction in active agent concentration. At the same time, the resultant cleavage of volatile, poisonous decomposition products presents a risk to the environment.

### SUMMARY OF THE INVENTION

Thus, the object was to find a usage form for biocides in thermoplastic molding compositions, which does not release, during processing, any dusts or gases dangerous to health, is compatible with the thermoplastic molding composition, comprises a high filler content, is flowable and does not cause heat damage to the biocide as a result of the production process.

### DETAILED DESCRIPTION OF THE INVENTION

The invention provides biocide batches which are characterized in that they comprise a mixture of

(a) 10 to 99.9, preferably 50 to 90 wt. % of factice and/or epoxidized and then cross-linked esters of at least dihydric alcohols and unsaturated fatty acids or cross-linked native oils and

(b) 0.1 to 90, preferably 10 to 50 wt. % of conventional biocides.

Factices are colorless or colored substances which are obtained by cross-linking native oils, e.g. through the action of sulfur chloride or sulfur on fatty oils (such as rape-seed oil, fish oils). A further possible method of production involves the cross-linking of hydroxyl group-containing oils, such as castor oil, by means of polyfunctional isocyanates, e.g. toluene 2,6-diisocyanate, to yield so-called polyurethane factices. The following are preferred: brown factices based on rape-seed oil and sulfur, together with PU factices based on castor oil and 4,4′-diisocyanatodiphenylmethane.

Epoxidized and then cross-linked esters of at least dihydric alcohols and unsaturated fatty acids, in particular, the glycerides of such fatty acids are described for the purposes of the present invention in EP-A 121 699.

They may be obtained by firstly epoxidizing appropriate esters and then cross-linking them by means of suitable polyfunctional cross-linking agents reacting with epoxy groups, such as polycarboxylic acids, polyamines, polyhydroxy compounds or polythiol compounds. Suitable di- or polycarboxylic acids are, for example, succinic, phthalic, terephthalic and isophthalic acid and trimellitic acid, Suitable polyamines are for example ethylenediamine, diethylenetriamine, hexamethylenediamine and phenylenediamine. Suitable polyhydroxy compounds are, for example, glycerol, glycol, diglycol, pentaerythritol, trimethylolpropane, hydroquinone, pyrogallol and hydroxycarboxylic acids esterified with polyalcohols. Suitable polythiol compounds are for example 1,2-ethanethiol, trimethylolpropane tri-3-mercaptopropionate, pentaerythritol tetra-3-mercaptopropionate and dithiophosphoric acids. Suitable cross-linking agents may also contain different functional groups in one molecule, such as 2-aminoethanol or 6-aminohexanoic acid.

Suitable, at least dihydric and preferably trihydric alcohols are, for example, glycerol, glycol, pentaerythritol, trimethylolpropane and/or sorbitol. Preferred esters are the natural triglycerides of unsaturated fatty acids, the so-called fatty oils, for example rape-seed oil, linseed oil, soya oil and fish oil.

The cross-linking agents are caused to react with the epoxidized fatty oils, which exhibit epoxide contents of from 1.5 to 15 wt. % (wt. % of oxygen relative to epoxidized fatty oil), preferably 4 to 8 wt. %, in amounts of from 3 to 50 wt. % at temperatures of from 80 to 180° C., preferably 100 to 150° C., wherein solid and semi-solid polymers are obtained.

The addition of the cross-linking agents is such that there is approximately one cross-linkable group of cross-linking agent per epoxy group. In the event of incomplete stoichiometric conversion, the cross-linking product should preferably still contain epoxide groups. Three-dimensionally cross-linked epoxidized soya oils are preferably used as component a).

Commercially available biocides are understood to mean fungicides, microbiocides, insecticides, termiticides and algicides. Fungicides or microbiocides which may be used in the mixture according to the present invention are, for example, 10,10′-oxy-bis-phenoxyarsine (OBPA), N-(trifluoromethylthio)phthalimide, N-trichloromethylthio)-phthalimide, N-dichlorofluoromethylthiophthalimide, diphenylantimony 2-ethylhexanoate, copper 8-hydroxyquinoline, 2-methoxycarbonylamino-benzimidazole, 3-iodo-2-propynyl butylcarbamate, 2-iodo-2-propynyl butylcarbamate, tributyltin oxide and derivatives thereof, 1,2-benzisothiazolin-3-one, 2-n-octyl-4-isothiazolin-3-one, N-butyl-1,2- benzisothiazolin-3-one and 4,5-dichloro-2-n-octyl-isothiazolin-3-one.

Suitable termiticides are compounds from the group including pyrethroids, e.g. cyclopropanecarboxylic acid ester, 3-(2,2-dichloro-ethenyl)-2,2-dimethyl ester, cyano-(4-fluoro-3-phenoxyphenyl)methyl ester.

10,10′-oxy-bis-phenoxyarsine, N-butyl-1,2-benzisothiazolin-3-one, N-dichlorofluoromethylthiophthalimide and 2-methoxycarbonylamino-benzimidazole are preferably used as biocides.

The anti-microbial action of the stated biocides in thermoplastic molding compositions is known and is described for example in “Taschenbuch der Kunststoff-Additive”, Eds. R. Gächter and H. Müller, Carl Hanser Verlag, Munich, 2nd edition (1979), pages 453-469.

The biocides may be contained in the biocide batch, individually or as a mixture.

The biocide batches according to the present invention may be produced with slight exposure to elevated temperatures on various units conventional in process engineering. Suitable units are, for example, stirred-tank reactors, extruders, closed mixers, rapid mixers, kneaders with and without plunger and mixing rolls.

The polymeric binding material is initially introduced into the mixing unit. The mixer is switched on and the binding material is briefly broken down. The biocides or biocide mixtures are then added to the binder in portions. The biocides may be apportioned in solid or liquid form. If necessary, solid or highly viscous biocides may be liquified or reduced in viscosity by previous heat treatment. After a few minutes a homogeneous mixture is obtained, which no longer dusts and is flowable.

Due to the low processing temperatures, in the range of from 20 to 100° C., preferably 30 to 60° C., no thermal damage is caused to the active agent during production of the biocide batch and thus no active agent is lost and no toxic decomposition products arise.

The biocide batches according to the present invention are used against microbial degradation of thermoplastic molding compositions. To this end, the biocide batches according to the present invention are incorporated into the thermoplastic molding compositions, comprising polyolefins, polyethers, polyesters, polyamides, polyurethane and polyvinyl chloride (PVC) by means of units conventional in plastics processing, e.g. extruders, kneaders, rolls and calenders. The biocide batches are particularly suitable for stabilizing PVC and thermoplastic polyurethanes (TPU). The quantity of biocide batches according to the present invention, which is added, depends on the active agent concentration established in the biocide batch and amounts to from 0.05 to 5 wt. %, preferably 0.1 to 1 wt. %, relative to the pure active agent in the finished product.

### EXAMPLES

Mixtures produced:

| | | |
|---|---|---|
| 1. | Epoxidized cross-linked ester¹ | 40 parts by weight |
| | N-butyl-1,2-benzisothiazolin-3-one | 60 parts by weight |
| | Epoxidized cross-linked ester¹ | 90 parts by weight |
| | N-dichlorofluoromethylthiophthalimide | 5 parts by weight |
| | 2-methoxycarbonylaminobenzimidazole | 5 parts by weight |
| 3. | PU factice² | 50 parts by weight |
| | N-dichlorofluoromethylthiophthalimide | 50 parts by weight |
| 4. | PU factice² | 90 parts by weight |
| | 10,10′-oxy-bis-phenoxyarsine | 10 parts by weight |
| 5. | Brown factice³ | 80 parts by weight |
| | Cyclopropanecarboxylic acid, 3- | 20 parts by weight |
| | (2,2-dichloroethenyl)-2,2-dimethyl, cyano- | |
| | (4-fluoro-3-phenoxyphenyl)methyl ester. | |

¹The binder is an epoxidized soya oil three-dimensionally crosslinked with dicarboxylic acids, produced as per EP-A 121 699.
²The binder is a castor oil three-dimensionally cross-linked with diisocyanate.
³The binder is a rape-seed oil three-dimensionally cross-linked with sulfur.

Production Examples

The binder system consisting of the epoxidized, cross-linked ester is initially introduced into a kneader, the temperature of which is adjusted to 50° C. The quantity of biocide indicated under practical Example 1 is then added in portions. After addition, mixing proceeds for a further 3 mins and then the mixture is discharged. A non-dusting, non-stick, flowable, yellowy-brown mixture is obtained.

Example of use

Tests (for plastics-destroying and plastics-discoloring molds) were performed to Swiss test standard SNV 195 921.

Round test pieces 3 cm in diameter were prepared from the samples. The test pieces are sandwiched on both sides with agar. The nutrient medium consists of a lower, sterile agar layer and an upper, inoculated agar layer (10 ml each). The storage temperature was 26° C. and the mold incubation period was 4 weeks. The test was then assessed visually. The extent to which the test piece supports the growth of microorganisms and the size of the zone around the test piece without growth are a measure of microbiological activity.

The following test microbes were used:

Penicillium brevicaule Aspergillus niger Clasdosporium herbarum Aspergillus terreus Thom Chaetomium globosum Trichoderma viride Steptoverticillium reticulum The test pieces are assessed according to the following model:

TABLE 1

| Inhibition zone | | | |
|---|---|---|---|
| [mm] | Growth | Description | Assessment |
| 1 to n | none | more than 1 mm inhibition | good action |
| | | zone | |
| | | no growth on test piece | |
| 0 to 1 | none | up to 1 mm inhibition zone | good action |
| | | no growth on test piece | |
| 0 | none | no inhibition zone | good action |
| | | no growth on test piece | |
| 0/− | slight | no inhibition zone | borderline |
| | | slight growth on test piece | action |
| 0/− − | all over | no inhibition zone | inadequate |
| | | considerable growth on test | action |
| | | piece | |

Examples 1-5

In a conventional single-screw extruder, thermoplastic polyurethane (polyester TPU with a density of 1.2 g/cm³ and a Shore A hardness of 85) is compounded with various biocide batches at a melt temperature of 210° C. (see Table 1). Standard color sample sheets with dimensions of 60×10×40×2 mm (length×breadth×depth) are then injection-molded from these compounds by means of a commercial injection-molding machine, the test pieces being produced from these sample sheets.

TABLE 2
Overview of test mixtures used

| | | | Compara- | Compara- | Compara- |
|---|---|---|---|---|---|
| | | | tive | tive | tive |
| | Example 1 | Example 2 | Example 3 | Example 4 | Example 5 |
| Parts TPU | 99.2 | 99 | 100 | 90 | 99 |
| [wt. %] | | | | | |
| Parts | 0.8 | 1 | — | 10 | 1 |
| biocide | mixture 1 | mixture 3 | | | |
| batch | | | | | |
| [wt. %] | | | | | |
| Support, | Cross— | PU factice | — | poly- | TPU |
| biocide | linked | 50% | | styrene | 50% |
| batch | ester 40% | | | 95% | |
| Biocide in | N-butyl- | N-dich- | — | 10,10′- | N-dich- |
| biocide | 1,2- | lorofluoro- | | oxybis- | lorofluoro- |
| batch | benzi- | methyl- | | phenoxy- | methyl- |
| | sothia- | thiopthal- | | arsine 5% | thiophthal- |
| | zolin-3- | imide 50% | | | imide 50% |
| | one 60% | | | | |
| Total parts | 0.48 | 0.5 | 0 | 0.5 | 0.5 |
| biocide | | | | | |
| [wt. %] | | | | | |

Table 3 lists the results of the agar diffusion test.

TABLE 3
Test results

| | | | Compara- | Compara- | Compara- |
|---|---|---|---|---|---|
| | | | tive | tive | tive |
| | Example 1 | Example 2 | Example 3 | Example 4 | Example 5 |
| Penicillium | 1-2 | 0 | 0/− | 0-1 | 0-1 |
| brevicaule | | | | | |
| Aspergillus | 1-2 | 0 | 0/− | 0-1 | 0 |
| niger | | | | | |
| Clasdo- | 2-5 | 2-4 | 0-1 | 1-3 | 3-4 |
| sporium | | | | | |
| herbarum | | | | | |
| Aspergillus | 3-5 | 4 | 0/− | 1-3 | 4-6 |
| terreus Thom | | | | | |
| Chaetomium | 2-4 | 2-3 | 0/− | 1-5 | 0-2 |
| globosum | | | | | |
| Trichoderma | 0 | 0 | 0/− − | 0/− | 0/− |
| viride | | | | | |
| Steptover- | 5-7 | 4 | 0/− | 1-2 | 3 |
| ticillium | | | | | |
| reticulum | | | | | |

Example 6-10

Conventional PVC-P calendar formulations (100 parts PVC powder, 58 parts diisononyl phthalate, 10 parts calcium carbonate, 5 parts titanium dioxide and 2 parts Ba/Zn stabilizers are produced with and without biocides in a mixing unit conventional in the PVC industry (see Table 3). Flexible PVC films 2 mm thick are produced from these mixtures using commercial calenders, the test pieces then being obtained from these films.

TABLE 4
Overview of test mixtures used

| | | | Compara- | Compara- | Compara- |
|---|---|---|---|---|---|
| | | | tive | tive | tive Ex- |
| | Example 6 | Example 7 | Example 8 | Example 9 | ample 10 |
| Parts PVC- | 99 | 99.5 | 100 | 99 | 99.9 |
| P | | | | | |
| [wt. %] | | | | | |
| Parts | 0.5 | 0.5 | — | 1 | 0.1 |
| biocide | mixture 2 | mixture 4 | | | |
| batch | | | | | |
| [wt. %] | | | | | |
| Support, | Cross- | PU factice | — | diisodecyl | EVA |
| biocide | linked | 90% | | phthalate | 40% |
| batch | ester 90% | | | 95% | |
| Biocide in | N-dich- | 10,10′- | — | 10,10′- | N-dich- |
| biocide | lorofluoro- | oxybis- | | oxybis- | lorofluoro- |
| batch | methyl- | phenoxyar | | phenoxyar | methyl |
| | thiophthali | sine | | sine | thiophthal- |
| | mide/2- | 10% | | 5% | imide 60% |
| | methoxy- | | | | |
| | carbonyla | | | | |
| | mino- | | | | |
| | benzi- | | | | |
| | midazole | | | | |
| | 5%/5% | | | | |
| Total parts | 0.05 | 0.05 | 0 | 0.05 | 0.06 |
| biocide | | | | | |
| [wt.%] | | | | | |

Table 5 lists the results of the agar diffusion test.

TABLE 5
Test results

| | | | Compara- | Compara- | Compara- |
|---|---|---|---|---|---|
| | | | tive | tive | tive Ex- |
| | Example 6 | Example 7 | Example 8 | Example 9 | ample 10 |
| Penicillium | 0-1 | 1-2 | 0/− − | 1-2 | 0 |
| brevicaule | | | | | |
| Aspergillus | 0-1 | 1-3 | 0/− − | 2-4 | 0 |
| niger | | | | | |
| Clasdo- | 4-6 | 2-4 | 0/− − | 2-3 | 3-6 |
| sporium | | | | | |
| herbarum | | | | | |
| Aspergillus | 3-4 | 3-4 | 0/− − | 2-4 | 3-5 |
| terreus Thom | | | | | |
| Chaetomium | 5-6 | 4-5 | 0/− − | 3-5 | 4-6 |
| globosum | | | | | |
| Trichoderma | 0 | 0-1 | 0/− − − | 0 | 0/− |
| viride | | | | | |
| Steptover- | 4-5 | 4-5 | 0/− | 4-6 | 3-5 |
| ticillium | | | | | |
| reticulum | | | | | |

The two examples of application show that the biocide batches according to the invention exhibit better or just as good anti-microbial action as known biocide batches.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Biocide batches, comprising a mixture of
(a) 10 to 99.9 wt. % of factice or epoxidized and then cross-linked esters of at least dihydric alcohols and unsaturated fatty acids or cross-linked native oils or mixtures thereof and
(b) 0.1 to 90 wt. % of conventional biocides.

2. Biocide batches according to claim 1, wherein said epoxidized and then cross-linked ester component is a three-dimensionally cross-linked epoxidized soya oil.

3. A process for producing biocide batches comprising the mixing in mixing units of a mixture of
(a) 10 to 99.9 wt. % of factice or epoxidized and then cross-linked esters of at least dihydric alcohols and unsaturated fatty acids or cross-linked native oils or mixtures thereof and
(b) 0.1 to 90 wt. % of conventional biocides at temperatures of from 20 to 100° C.

4. Stabilizers against the degradation of thermoplastic molding compositions by insects, termites, fungi, microbes and bacteria comprising a mixture of
(a) 10 to 99.9 wt. % of factice or epoxidized and then cross-linked esters of at least dihydric alcohols and unsaturated fatty acids or cross-linked native oils or mixtures thereof and
(b) 0.1 to 90 wt. % of conventional biocides.

5. Stabilizers according to claim 4, wherein said thermoplastic molding is polyvinyl chloride.

6. Stabilizers according to claim 4, wherein said thermoplastic molding is thermoplastic polyurethane.
